(19) United States
(12) Patent Application Publication
(10) Pub. No.: US 2007/0119321 A1
(43) Pub. Date: May 31, 2007

(54) Method of manufacturing a surface structure of a clamping surface of a gripper system in a machine for processing sheets of printing material, gripper system, gripper bar and printing press

(75) Inventor: Greg Kasprzak, Wheeling, IL (US)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/517,500

(22) Filed: Sep. 7, 2006

(30) Foreign Application Priority Data
Nov. 17, 2005 (DE) 10 2005 054 953.5

(51) Int. Cl. B41F 1/30

(52) U.S. Cl. 101/408

(57) ABSTRACT

A method of manufacturing a surface structure of a clamping surface of a gripper system in a machine for processing sheets of printing material, includes generating the surface structure by the electrical discharge machining method. A gripper system, a gripper bar and printing press are also provided.

### Cross-Reference to Related Application

This application claims the priority, under 35 U.S.C. §119, of German Patent Application DE 10 2005 054 953.5, filed Nov. 17, 2005; the prior application is herewith incorporated by reference in its entirety.

### BACKGROUND OF THE INVENTION

### Field of the Invention

The present invention relates to a method of manufacturing a surface structure of a clamping surface of a gripper system in a machine for processing sheets of printing material. The present invention also relates to a gripper system, a gripper bar and printing press.

Such clamping surfaces must be roughened to hold the sheet securely without slippage. Several methods of roughening the clamping surface have become known:

In accordance with East German Patents DD 59 802 and DD 68 233, for example, the clamping surface is roughened by what is referred to as a sparking method, which is based on the creep of material phenomenon. According to the sparking method, preferably a hard metal or tungsten is applied to the clamping surface.

German Patent DE 43 00 266 C2 describes a different method of roughening the clamping surface by sandblasting.

German Published, Prosecuted Patent Application DE 14 11 126 and German Patent DE 36 18 444 C1, corresponding to U.S. Pat. No. 4,781,791, represent further prior art.

It is to be assumed that the surface structures of the clamping surfaces created by the sparking method and by sandblasting cannot hold the sheet with a sufficient degree of reliability. In particular, it is to be expected that, in particularly unfavorable operating conditions, clamping surfaces roughened in accordance with the prior art cannot hold the sheet without slippage between the sheet and the clamping surface. Such an unfavorable operating condition occurs, for example, when very sticky UV printing inks are printed onto the sheet. As a result of the stickiness of the UV printing inks, the sheet tends to adhere to the blanket cylinder that prints on the sheet. Consequently, the blanket cylinder exercises a pulling force on the sheet. The pulling force tends to pull the sheet out of the gripper system.

### SUMMARY OF THE INVENTION

It is accordingly an object of the invention to provide a method of manufacturing a surface structure of a clamping surface of a gripper system in a machine for processing sheets of printing material, a gripper system, a gripper bar and a printing press, which overcome the hereinafore-mentioned disadvantages of the heretofore-known methods and devices of this general type and in which the clamping surface is roughened in such a way that the clamping surface is able to hold the sheet with a sufficient degree of reliability, even in unfavorable operating conditions, in particular when printing with UV printing ink.

With the foregoing and other objects in view there is provided, in accordance with the invention, a method of manufacturing a surface structure of a clamping surface of a gripper system in a machine for processing sheets of printing material. The method comprises generating the surface structure by an electrical discharge machining method.

In contrast to the sparking method of the prior art (East German Patents DD 59 802 and DD 68 233), this electrical discharge machining method means that material is ablated.

In accordance with another mode of the invention, the surface structure is hardened by a surface hardening method in a method step following the application of the electrical discharge machining method.

In accordance with a further mode of the invention, the surface structure is protected against corrosion by an anti-corrosion method in a method step following the application of the surface hardening method.

With the objects of the invention in view, there is also provided, in a machine for processing sheets of a printing material, a gripper system comprising a clamping surface having a surface structure. The surface structure is manufactured by electrical discharge machining. The electrical discharge machining imparts distinctive structural characteristics to the final product, which are different from roughening provided by other methods and which can only be defined by a process step.

In accordance with another feature of the invention, the surface structure is hardened.

In accordance with a further feature of the invention, the surface structure is protected against corrosion.

In accordance with an added feature of the invention, the gripper system includes a gripper finger having the clamping surface and a gripper pad with a further clamping surface. The gripper pad cooperates with the gripper finger. The clamping surface of the gripper pad may have a regular surface structure.

With the objects of the invention in view, there is additionally provided a gripper bar in a machine for processing sheets of printing material. The gripper bar comprises gripper systems constructed in accordance with the invention or with one of the further developments thereof.

With the objects of the invention in view, there is concomitantly provided a sheet-fed printing press, comprising at least one gripper bar having gripper systems according to the invention.

Additional further developments that are advantageous in terms of function and construction of the method, gripper system, gripper bar, and sheet-fed printing press according to the invention, can be taken from the following description of a preferred exemplary embodiment and the associated drawing.

Other features which are considered as characteristic for the invention are set forth in the appended claims.

Although the invention is illustrated and described herein as embodied in a method of manufacturing a surface structure of a clamping surface of a gripper system in a machine for processing sheets of printing material, a gripper system, a gripper bar and a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a sheet-fed printing press;

FIG. 2 is an enlarged, front-elevational view of a gripper bar of the printing press, taken along a viewing direction II of FIG. 3, in the direction of the arrow;

FIG. 3 is a partly-sectional, side-elevational view of a gripper system of the gripper bar, taken along a line III-III of FIG. 2, in the direction of the arrows; and

FIG. 4 is a further enlarged, plan view of a clamping surface of the gripper system.

### DESCRIPTION OF THE PREFERRED EMBODIMENTS

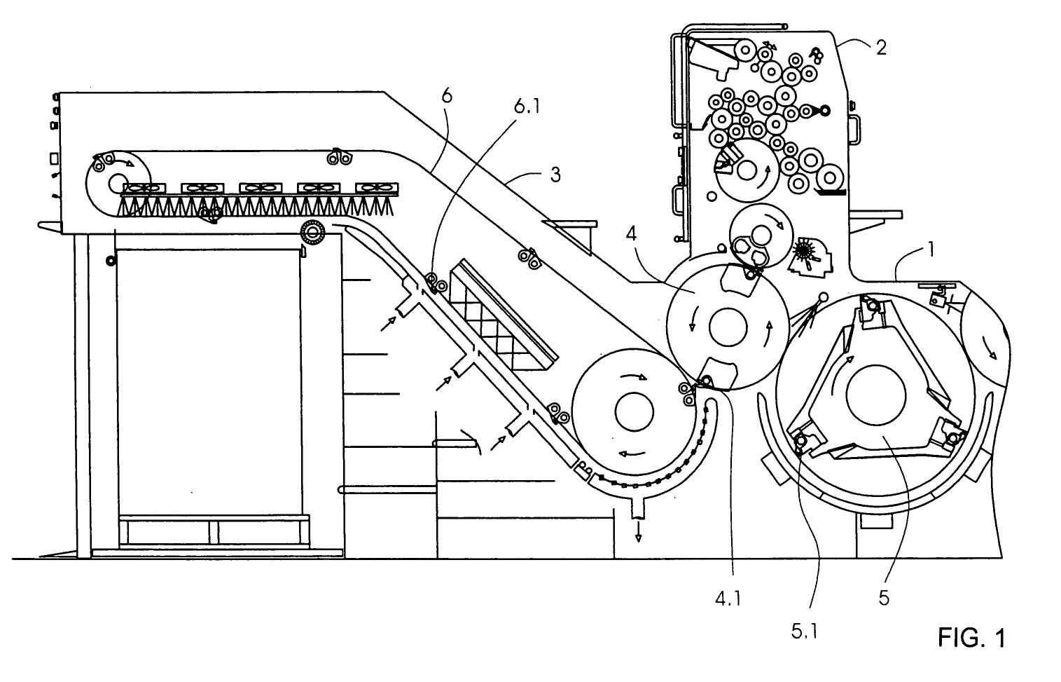

Referring now to the figures of the drawings in detail and first, particularly, to FIG. 1 thereof, there is seen a sheet-fed printing press 1 which includes a printing unit 2 for offset printing and a delivery 3. Among other elements, the printing unit 2 includes an impression cylinder 4 having gripper bars 4.1. A sheet transport drum 5 having gripper bars 5.1 is disposed upstream of the impression cylinder 4. The delivery 3 includes a chain conveyor 6 having gripper bars 6.1.

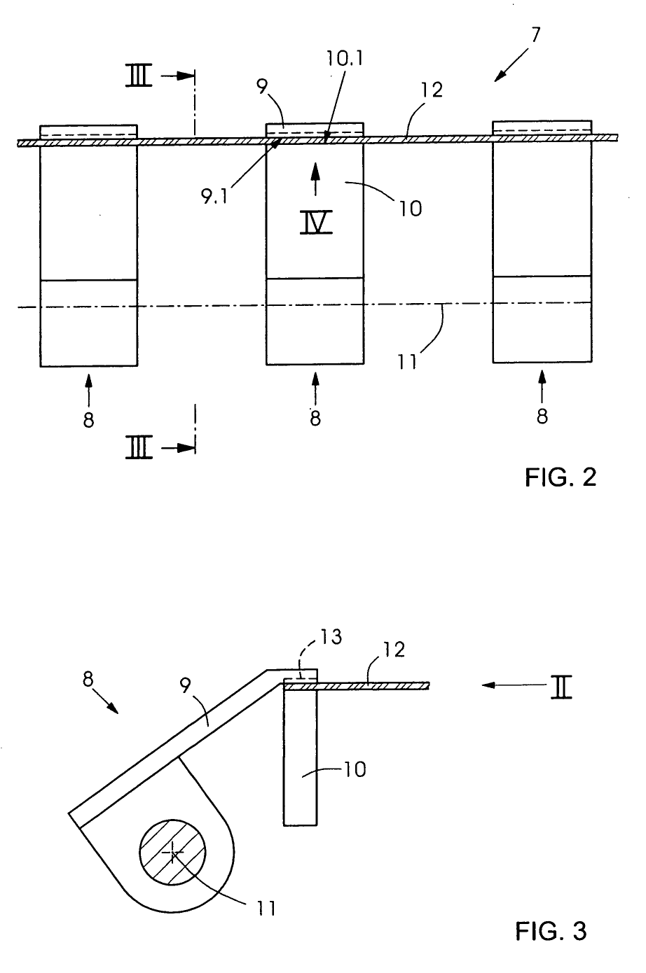

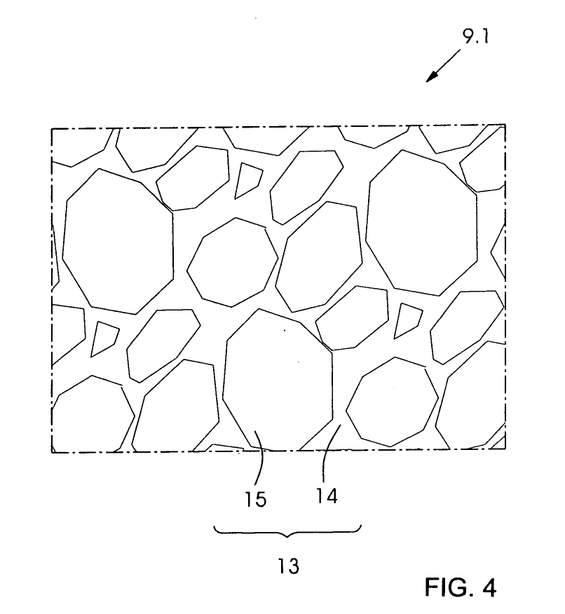

FIG. 2 is a view that is seen in a viewing direction II indicated in FIG. 3, and FIG. 3 is a view that is seen along a sectional line III-III indicated in FIG. 2. FIGS. 2 and 3 show a gripper bar 7, which may be one of the gripper bars 4.1 of the impression cylinder 4, one of the gripper bars 5.1 of the sheet transport drum 5, or one of the gripper bars 6.1 of the chain conveyor 6.

The gripper bar 7 includes gripper systems 8 that are disposed in a row. Each of the gripper systems 8 includes a gripper finger 9 having a clamping surface 9.1 and a gripper pad 10 including a clamping surface 10.1. The gripper fingers 9 are pivotable about a pivot axis 11 to clamp a sheet 12 of printing material between the clamping surface 9.1 of the gripper finger 9 and the clamping surface 10.1 of the gripper pad 10 of the respective gripper system 8.

As is shown in FIG. 4, the clamping surface 9.1 of the gripper finger 9 of each one of the gripper systems 8 has an irregular surface structure 13 with raised portions 14 and depressions 15. The surface structure 13 has been produced in accordance with the following method: in order to generate the depressions 15, the clamping surface 9.1, which is made of a metal (steel), is subjected to an electrical discharge machining treatment in a machine for electrical discharge machining. After the electrical discharge machining treatment, the surface structure 13 is hardened through the use of a hardening device. In a last method step, the hardened surface structure 13 is subjected to an anti-corrosion treatment. The surface hardening of the surface structure 13 and the anti-corrosion treatment ensure a long life of the roughening.

The gripper pad clamping surface 10.1, which cooperates with the clamping surface 9.1 of the gripper finger, is likewise made of a metal (steel) and likewise has a surface structure, which is not shown in greater detail in the drawing. In contrast to the surface structure 13 of the clamping surface 9.1 of the gripper finger 9 shown in FIG. 4, the surface structure of the clamping surface 10.1 of the gripper pad 10 is regular and formed, for example, by what is referred to as cross-grooves. Thus, the clamping surface 9.1 of the gripper finger 9 has a micro-roughness and the clamping surface 10.1 of the gripper pad 10 has a macro-roughness.

The properties of the surface structure 13 of the clamping surface 9.1 of the gripper finger 9 ensure an extremely high degree of static friction and thus considerably reduce the amount of slippage that occurs between this clamping surface 9.1 and the sheet 12. Consequently, the sheet 12 is held by the gripper system in an absolutely reliable way and in register even in the case of very unfavorable operating conditions.

Such unfavorable operating conditions, wherein external pulling forces acting on the sheet 12 act to pull the sheet 12 out of the gripper systems 8 that hold the sheet 12 may, for example, result from a high surface coverage of the sheet 12 with printing ink, in particular UV printing ink. Sheets 12 that are printed in this way tend to adhere to the blanket cylinder, and the occurring adhesive force acts to pull the sheet 12 out of the gripper bar 4.1 of the impression cylinder 4. This phenomenon is avoided by the surface structure 13 that has been produced by electrical discharge machining.

I claim:

1. A method of manufacturing a surface structure of a clamping surface of a gripper system in a machine for processing sheets of printing material, the method comprising the following step:
generating the surface structure by an electrical discharge machining method.

2. The method according to claim 1, which further comprises hardening the surface structure by a surface hardening method in a method step following the step of generating the surface structure by an electrical discharge machining method.

3. The method according to claim 2, which further comprises protecting the surface structure against corrosion by an anti-corrosion method in a method step following the step of hardening the surface structure by a surface hardening method.

4. In a machine for processing sheets of a printing material, a gripper system comprising:
a clamping surface having a surface structure, said surface structure being manufactured by electrical discharge machining.

5. The gripper system according to claim 4, wherein said surface structure is hardened.

6. The gripper system according to claim 4, wherein said surface structure is protected against corrosion.

7. The gripper system according to claim 4, which further comprises a gripper finger having said clamping surface, and a gripper pad having a clamping surface cooperating with said gripper finger.

8. The gripper system according to claim 7, wherein said clamping surface of said gripper pad has a regular surface structure.

9. In a machine for processing sheets of printing material, a gripper bar comprising gripper systems according to claim 4.

10. A sheet-fed printing press, comprising at least one gripper bar having gripper systems according to claim 4.
